(19) United States
(12) Patent Application Publication
(10) Pub. No.: US 2021/0172883 A1
(43) Pub. Date: Jun. 10, 2021

(54) SYSTEM AND METHOD FOR PASSIVELY MONITORING A SAMPLE

(71) Applicant: ContinUse Biometrics Ltd., Tel Aviv (IL)

(72) Inventors: Zeev ZALEVSKY, Rosh HaAyin (IL); Hadar GENISH, Petah-Tikva (IL)

(21) Appl. No.: 17/109,973

(22) Filed: Dec. 2, 2020

Related U.S. Application Data
(60) Provisional application No. 62/943,950, filed on Dec. 5, 2019.

(51) Int. Cl. G01N 21/956

(52) U.S. Cl. CPC G01N 21/95623; G01N 2021/479

(57) ABSTRACT

A system for passively monitoring a sample is disclosed. The system comprises an optical arrangement, a filtering unit and a detector unit. The optical arrangement is configured for collecting light arriving from a sample, directing the collected light to the filtering unit for filtering based on at least one of spatial and spectral composition and directing the collected light onto the detector unit. The optical arrangement and the detector unit are arranged to provide imaging of collected light from the sample on the detector unit with selected focusing/defocusing level to generate image data pieces comprising speckle patterns formed in the collected light.

### TECHNOLOGICAL FIELD

The present invention is in the field of optical monitoring and is particularly relevant for passive monitoring parameters of mechanical or biological samples.

### BACKGROUND ART

References considered to be relevant as background to the presently disclosed subject matter are listed below:
Z. Zalevsky, D. Mendlovic and H. M. Ozaktas, “Energetic efficient synthesis of mutual intensity distribution,” J. Opt. A: Pure Appl. Opt. 2, 83-87 (2000);
V. Mico, J. Garcia, C. Ferreira, D. Sylman and Zeev Zalevsky, “Spatial Information Transmission Using Axial Temporal Coherence Coding,” Opt. Lett. 32, 736-738 (2007);
Z. Zalevsky, J. Garcia, P. Garcia-Martinez and C. Ferreira, “Spatial information transmission using orthogonal mutual coherence coding,” Opt. Lett. 20, 2837-2839 (2005);
V. Mico, E. Valero, Z. Zalevsky and J. Garcia, “Depth sensing using coherence mapping,” Opt. Commun. 283, 3122-3128 (2010).

Acknowledgement of the above references herein is not to be inferred as meaning that these are in any way relevant to the patentability of the presently disclosed subject matter.

### BACKGROUND

Secondary speckle patterns are generally random light interference patterns that typically occur in laser light reflected from diffusive material. When a surface is illuminated with coherent illumination (e.g. laser light), light components reflected or scattered from different locations of the illumination spot interfere between them and generate certain interference pattern known as secondary speckle pattern.

As the pattern of secondary speckles is associated with parameters of the illuminated surface (e.g. surface roughness, alignment, etc.), monitoring variations in the speckle patterns is used in various applications for determining parameters of the material or object from which the light is reflected. Monitoring of the speckle pattern variation may be based on changes in contrast of the speckle pattern within given exposure time per frame or based on monitoring spatial correlations between the speckle patterns along time.

The variations in speckle patterns may be associated with micro- and nano-vibrations of surface of the sample. The surface vibrations are collected based on changes in the speckle patterns and can provide data indicative on mechanical operation profile of the sample. For example, vibration of human skin can be indicative of pulsating blood flow, acoustic sounds associated with speech, breathing etc. In some applications, selected external stimulation is used for monitoring response of the sample through variations in the speckle patterns.

### GENERAL DESCRIPTION

There is a need in the art for a novel technique enabling monitoring micro- or nano-vibrations of a sample while omitting the need for use of laser illumination directed at the sample. The present invention utilizes radiation arriving from an object of interest, being a result of thermal emission (e.g. IR radiation) or reflection of ambient light, for identifying speckle patterns. The technique further utilizes monitoring of variations in the detected speckle patterns for determining one or more parameters of the sample. In this connection it should be noted that the term light as used herein should be understood broadly as relating to electromagnetic radiation being optical or non-optical. For example, thermal radiation emitted from objects may vary in accordance with temperature of the object and in typical conditions (e.g. room temperature) the thermal radiation comprise mostly infra-red radiation. Accordingly, the term light as used herein refers generally to electromagnetic radiation of wavelength range selected by the spectral filtering unit when used.

The present invention utilizes at least one of spatial and spectral filtering of radiation arriving from the sample, and detection of the filtered radiation for generating speckle pattern data. More specifically, by filtering light of relatively narrow wavelength range and/or light associated with specific spatial location, coherence of the collected light is improved, allowing formation of visible interference effects such as speckle pattern in the collected light.

Accordingly, the present invention provides a measurement system comprising filtering unit (or coherence enhancing unit) and a detector array and may also comprise an optical imaging unit configured in accordance with the selected wavelength selected by the filtering unit. The filtering unit is configured for filtering collected radiation such that radiation is collected from selected spatial region (spatial filtering). In some embodiments, the filtering unit may also comprise spectral filter configured to allow collection of radiation within selected spectral bandwidth (wavelength range).

The present technique utilizes enhancement of coherence condition of collected light, e.g. emitted by thermal radiation from the object or ambient light reflected from the object. The coherence may be enhanced by using a spectral filter having a relative narrow bandwidth (e.g. 10-100 nm), and/or certain spatial encoding/filtering of the collected light.

Thus, according to a broad aspect, the present invention provides a system comprising: optical arrangement (e.g. optical lens arrangement), filtering unit and a detector unit; the optical arrangement is configure for collecting light arriving from a sample, directing the collected light to the filtering unit for filtering based on at least one of spatial and spectral composition and directing the collected light onto the detector unit, the optical arrangement and the detector unit are arranged to provide imaging of collected light from the sample on the detector unit with selected focusing/defocusing level.

According to some embodiments, the system is configured for generating detector output data comprising of one or more image data pieces, said image data pieces comprising speckle patterns formed in light collected from the sample.

According to some embodiments, the filtering unit comprises at least one of spatial filtering unit and spectral filtering unit. Alternatively or additionally, the filtering unit may comprise a coherence shaping unit configured for enhancing at least one of spatial and temporal coherence properties of the collected light. The filtering may be configured to enhance coherence of the collected light to thereby increase contrast of speckle patterns formed in the collected light.

According to some embodiments, the filtering unit may comprise spatial filtering unit and spectral filtering unit; the spatial filtering unit is configured for enhancing coherence of light components collected from a common spatial position on the sample, said spectral filtering unit is configured for filtering light components for directing light components of a selected wavelength range onto a one or more defined regions on the detector unit.

According to some embodiments, the spectral filtering unit may comprise one or more dichroic filters configured for transmitting or reflecting a selected wavelength range.

According to some embodiments, the optical arrangement may be positioned to provide defocused imaging of the object, thereby generating defocused image of collected light on the detector unit. Such defocused image may form one or more speckle patterns of the detector unit. The detector unit is typically configured for collecting image data pieces indicative of said one or more speckle patterns at a selected sampling rate to provide image data sequence comprising at least one sequence of speckle patterns.

According to some embodiments, the system may further comprise a control unit connected to at least said detector array and configured for receiving detector output data comprising one or more sequences of image data pieces and for processing said one or more sequences and determining data indicative of one or more parameters of the sample.

According to some embodiments, the control unit comprises at least one processor unit, said control unit is adapted for receiving image data pieces from the detector array and for operating the processor unit for processing said image data pieces for determining variations in speckle patterns in accordance with sampling rate of the detector array.

According to some embodiments, the processing comprises determining variation in spatial correlation between speckle pattern in different image data pieces, and determining a time-correlation function, said time-correlation function is indicative of variations in at least one of location and orientation of surface of the sample.

According to some embodiments, the spatial filtering unit may be configured as an interferometric unit configured for generating output light being a result of interference of at least two copies of collected light arriving from the object.

The interferometric unit may comprise a beam splitting element configured to receive collected light and split the collected light to form said at least two copies, said interferometric unit further comprises at least first and second arms allowing light components of said at least two copies to propagate therethrough along selected optical paths, and to combine light components from said first and second arms to provide output light.

According to some embodiments, the collected light arriving from the sample may comprise thermal radiation emitted for the sample or ambient light reflected from the sample.

According to some embodiments, the spatial filtering unit may comprise a selected aperture or pinhole and utilize one or more scattering medium associated with the sample and located downstream of the aperture with respect to direction of propagation of collected radiation.

According to some embodiments, the spatial filtering unit may be formed by an aperture unit mounted on an endoscope, said one or more scattering medium being associated with additional tissue located exterior from the aperture unit.

According to one other broad aspect, the present invention provides a method for monitoring an object, the method comprising collecting electromagnetic radiation originating from the object by thermal radiation or reflection of ambient light, passing the collected radiation through at least one of spectral and spatial filter for enhancing coherence of the collected radiation, and collecting image data pieces at a selected sampling rate, the image data pieces comprise speckle patterns formed in the collected radiation. The method may further comprise processing the collected image data pieces for determining variations in the speckle pattern along time, thereby determining one or more parameters of the object.

According to some embodiment, said processing comprises determining correlations between image data piece to determine spatial variations of the speckle patterns between time of acquisition of said image data pieces and determining at least one time-correlation function indicative of one or more parameters of said object.

According to some embodiments, said passing the collected light through at least one of spectral and spatial filter comprises passing the collected light through at least one spectral filter having bandpass width not exceeding 0.5 nm, and passing the collected light through a spatial filter for enhancing spatial coherence of the collected light.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a system for monitoring an object according to some embodiments of the present invention;

FIG. 2 illustrates an exemplary experimental system used for determined variation of speckle pattern collected for source of thermal radiation;

FIGS. 3A to 3C show speckle patterns collected experimentally by the system of FIG. 2;

FIGS. 4A to 4C exemplify horizontal (FIG. 4A) and vertical (FIG. 4B) cross sections of desired mutual coherence function and pattern of phase mask (FIG. 4C) used for enhancing coherence to the desired coherence;

FIGS. 5A to 5C exemplify additional horizontal (FIG. 5A) and vertical (FIG. 5B) cross sections of corresponding desired mutual coherence function and pattern of phase mask (FIG. 5C) used for enhancing coherence to the desired coherence;

FIGS. 6A and 6B exemplify spatial filtering unit configured by interferometric unit suitable for use in the technique of the present invention, FIG. 6A exemplifies coherence encoding arrangement, and FIG. 6B exemplifies coherence encoding and decoding arrangement; and

FIG. 7 exemplifies another configuration of spatial filtering unit configured by interferometric unit suitable for use in the technique of the present invention.

### DETAILED DESCRIPTION OF EMBODIMENTS

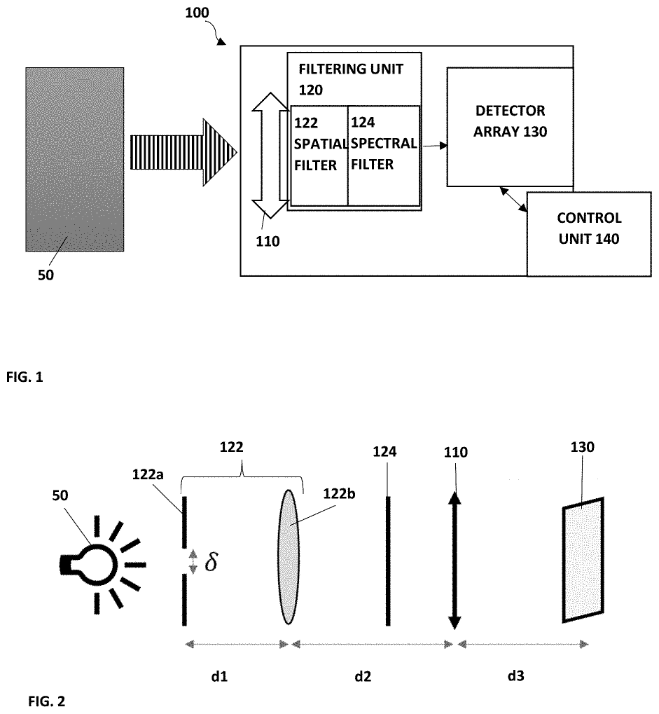

Reference is made to FIG. 1 illustrating schematically a system 100 configured for monitoring an object 50 according to the present technique. The system 100 includes filtering unit 120 and a detector array 130 and may in some configurations also include an optical lens arrangement 110. Also, the system 100 may typically include a control unit 140 configured for operating the detector array 130 and for processing, or pre-processing, of image data pieces collected by the detector array 130 and generating data indicative of one or more parameters of the object 50 being monitored. System 100 is generally adapted for collecting and filtering radiation arriving from the object 50 for generating one or more sequences of image data pieces indicative of spackle patterns formed in the collected radiation. When operated with processing of the control unit 140, system 100 provides for monitoring object 50 and determining one or more selected parameters of the object 50.

The filtering unit 120 includes at least one of spatial filter 122 and spectral filter 124 or corresponding spatial and/or spectral filtering units, configured for filtering collected light for improving one or more conditions of coherence of the collected light. Preferably, according to some embodiments, the filtering unit 120 includes both spatial filtering unit 122 and spectral filtering unit 124. The spectral filtering unit 124 may typically be a spectral filter, a chromatic filter or any other filter configured for transmitting light with narrow bandwidth around a selected wavelength range. As described in more detail below, the spectral filter may transmit light in a selected visible wavelength, selected wavelength in infra-red range or any other wavelength selected in accordance with parameters of the object 50 to be monitoring and sensitivity of the detector array 130. The spatial filtering unit 122 is configured for improving spatial coherence of collected light. For example, the spatial filtering unit 122 may be formed of a pinhole transmitting light arriving from a selected, relatively small, location of the object 50. It should however be noted that, a pinhole also operates as a low pass filter and may limit collection of spatial information of the object 50. To overcome such limitation, in some configuration the spatial filtering unit 122 may include a self-interferometric optical arrangement configured for interfering collected light with itself to enhance spatial coherence. In some configurations, the spatial filtering unit 122 may be formed by a phase mask having phase affecting patterns selected to provide desired coherence function of light passing through the mask as described in more detail below. Specifically, the spatial filtering unit 122 is configured for enhancing spatial coherence of collected light while maintaining certain spatial information in the collected light, to thereby enable monitoring of parameter of the object 50.

The optical lens arrangement 110, when used, may generally be located upstream of the filtering unit 120, at an intermediate location between elements of the filtering unit 120, or between the filtering unit 120 and the detector array 130 in accordance with specific configuration of the system as described in more detail further below. The optical lens arrangement 110 is typically configured to provide imaging of a selected inspection region on the object 50 to be collected by the detector array 130. In some configurations, the optical lens arrangement 110 is configured and positioned to provide imaging of the selected region of the object 50 with selected focusing or defocusing level. More specifically, the optical lens arrangement 110 may be configured with field of view collecting light arriving from the selected inspection region of the object 50, while imaging an intermediate plane located between the object 50 and the optical lens arrangement onto the detector array 130.

The control unit 140 is connected to at least the detector array 130 and configured for operating the detector array for collecting at least one sequence image data pieces with selected sampling rate and selected exposure time for each image frame. The image data pieces may each be assigned with time stamp indicative of time of collection. Additionally or alternatively, the image data pieces may be collected at selected time difference between them. The control unit 140 is further configured for receiving collected image data pieces and for processing the image data pieces for determining data on one or more parameters of the object 50. To this end the control unit 140 generally includes a processing unit, e.g. including at least one processor, which is not specifically shown in FIG. 1. The processing unit is adapted for processing received image data pieces for determining variations in speckle patterns between image data pieces collected at different times.

Generally, the control unit 140 may operate for storing received image data pieces in a respective memory unit (e.g. random-access memory RAM unit) enabling processing of image data pieces taken with different time stamps. The processing unit utilizes received image data pieces and data pieces stored in the memory unit for determining one or more correlation measures between speckle pattern in the image data piece. For example, the processing unit may determine correlation measure between pairs of consecutively collected image data pieces (e.g. first and second images, second and third images, etc.). Additionally or alternatively, the processing unit may determine correlations between speckle patterns in collected images with respect to a selected image (e.g. second and first images, third and first images, etc.) Generally, speckles are regions of high and low radiation intensity formed by self-interference of light/radiation components. This self-interference typically creates regions of destructive and constructive interference, resulting in regions of high and low intensity that is visible in coherent (or relatively coherent radiation). The self-interference patterns generally occur also in non-coherent radiation but are almost unseen sue to short coherence time and integration of any detection technique that averages the pattern. As indicated above, the present invention utilizes at least one of spatial and spectral filtering (and preferably both spatial and spectral filtering) of collected light, to improve coherence of the collected light enabling to identify speckle patterns on image data pieces.

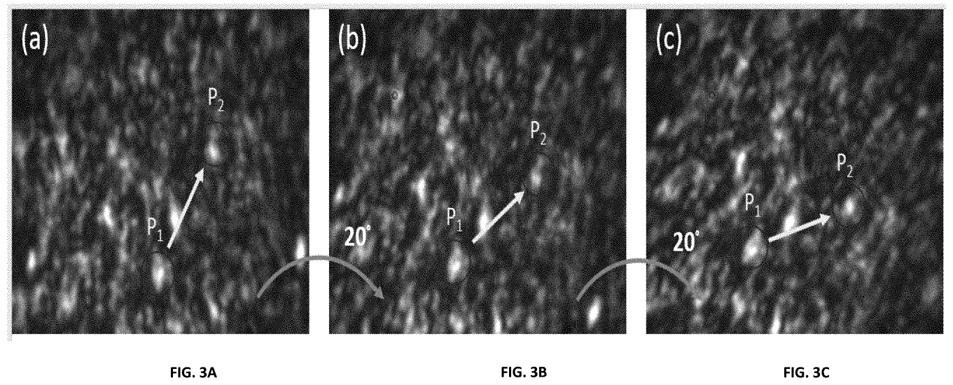

In some exemplary tests, the inventors of the present invention use a pinhole located upstream of a diffuser element as spatial filter, enabling to transmit light arriving from a small region of the inspected object. FIG. 2 exemplifies a system for monitoring parameters of an object according to some embodiments of the present technique. In this configuration, a halogen lamp is used as object 50. A pinhole 122a (e.g. δ=10-1000 μm in diameter) is placed close to the lamp to increase the spatial coherence of collected light, a diffuser 122b is places downstream of the pinhole 122a, providing together a spatial filter arrangement 122. The diffuser 122b is mounted on a rotation mount and positioned at a distance d1 (e.g. 80 mm) mm from the pinhole 122a. The spectral filter 124 used in this test is an ultra-narrowband filter centered around 532.3 nm with a 0.3 nm FWHM. An imaging lens 110 is used, positioned to provide defocused, or Fourier, imaging of diffuser 122b onto the detector array 130. In a specific exemplary test, the lens 110 used has f=25 mm and is positioned at a distance d2=100 mm from the diffuser and d3=65 mm from the detector array 130.

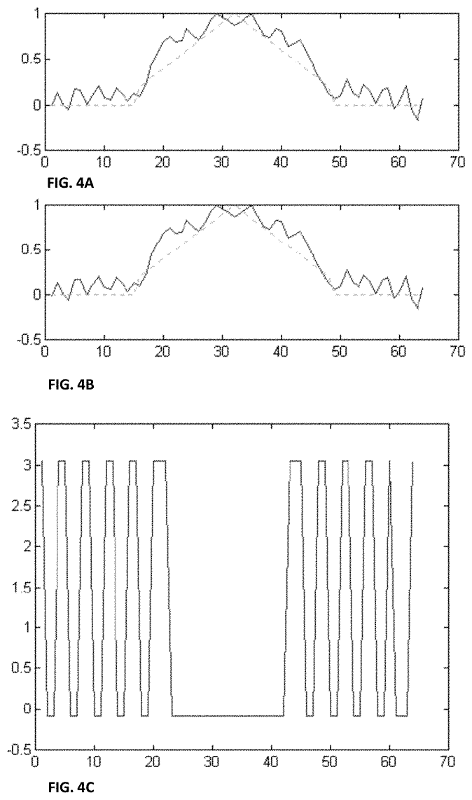

Reference is made to FIGS. 3A to 3C showing image data pieces obtained by experiments using the system as described in FIG. 2. FIGS. 3A to 3C show image frames obtained for different orientations of the diffuser 122b respectively at 0°, 20°, and 40° relative orientation. Each of the images show a pattern of speckles obtained in collecting image data resulting from light emitted by a non-coherent source 50, being a halogen lamp. Moreover, the changes in orientation of the diffuser can be seen based on relative orientation between speckles P1 and P2 rotating between FIGS. 3A to 3C.

It should be noted that the variations in speckle patterns exemplified in FIGS. 3A to 3C are typically a result of changes in relative location/orientation between the diffuser 122b and the radiation source (object 50). Accordingly, shifts and movements of the object 50, generate variations in the collected speckle patterns enabling use of this configuration for passively monitoring an object.

Further, as indicated above, the use of pinhole may affect the level of data that can be collected using the present technique. This is since pinhole provides spatial filtering in the form of low pass filter with respect to spatial frequencies, thereby causing loss of information. Generally, the use of pinhole 122a as spatial filter may be advantageous when combined with diffuser layer located between the pinhole and detector 130. For example, a pinhole mask may be used, surgically inserted (e.g. using an endoscope or via laparotomy) into a body and positioned in front of one or more organs to be inspected. The organ, generally emitting infra red illumination by thermal emission, can thus be monitored by detecting variation in speckle patterns of thermal radiation as appearing on the skin, where the skin itself, and/or blood or other tissue located downstream of the pinhole with respect to general direction of propagation of collected radiation act as diffuser 122b.

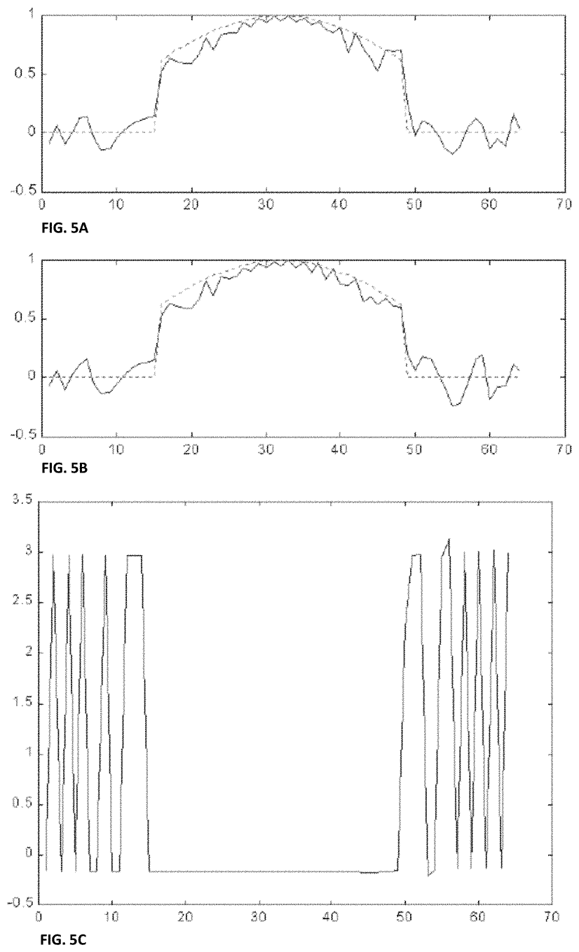

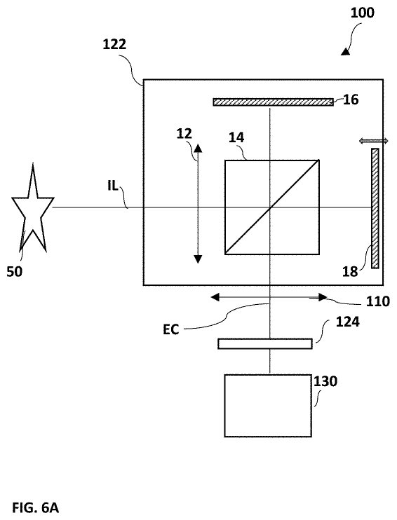

Alternatively, and preferably, the present invention may utilize spatial filter 122 configured as phase mask or selected self-interferometric unit for enhancing spatial coherence of the collected light. Reference is made to FIGS. 4A to 4C and 5A to 5C exemplifying simulation results indicating enhancement of spatial coherence in light using phase-only mask having phase pattern exemplified in FIGS. 4C and 5C respectively. The dashed lines in FIGS. 4A-4B and 5A-5B show the desired mutual coherence functions and the solid lines show the simulated result of the coherence function. More specifically, FIGS. 4A and 4B show respectively horizontal a vertical cross section of mutual coherence function of light, originating from a gaussian mutual coherence of the form J₀ (x₁, x₂)=exp(−(x₁−x₂)²/2σ²), and being transferred through phase mask having phase affecting pattern as exemplified in FIG. 4C. The phase mask of FIG. 4C is designed for generating mutual coherence distribution function of the form:

$${J}_{1} ( {x}_{1} , {x}_{2} ) = Λ ( \frac{\vert {x}_{1} - {x}_{2} \vert}{2 {r}_{1}} ) rect ( \frac{{x}_{1}}{2 {r}_{2}} ) rect ( \frac{{x}_{2}}{2 {r}_{2}} )$$

Where Λ(x) is triangle function

$$Λ ( x ) = 1 - \vert \frac{x}{Δ x} \vert ,$$

rect(x) is rectangle function rect(x)=1 for |x|<Δx/2, and zero otherwise. The phase mask may be formed of a central flat phase region, surrounded by rings of varying phase pattern, e.g., between first and second phase variations such as 0 and pi, 0 and pi/2 etc. Similarly, FIGS. 5A and 5B show respectively horizontal and vertical cross sections of mutual coherence function of light, originating from similar coherent conditions and transmitted through a phase mask as exemplified in FIG. 5C. The phase mask of FIG. 5C is designed for generating mutual coherence distribution function of the form:

$${J}_{2} ( {x}_{1} , {x}_{2} ) = sinc ( \frac{{x}_{1} - {x}_{2}}{{r}_{1}} ) rect ( \frac{{x}_{1}}{2 {r}_{2}} ) rect ( \frac{{x}_{2}}{2 {r}_{2}} )$$

Where sinc(x)=sin(x)/x. This mask may also be formed of central flat phase region surrounded by rings of variation phases, typically varying between first and second phase affecting levels.

The phase pattern of the phase mask may for examples be determined in accordance with Z. Zalevsky et al “Energetic efficient synthesis of mutual intensity distribution,” J. Opt. A: Pure Appl. Opt. 2, 83-87 (2000). describing a formulation of phase mask pattern determined for generating desired mutual coherence functions based on given coherence condition of input light and incorporated herein by reference. It should be noted that the phase mask is generally designed with respect to wavelength selected by spectral filter 124.

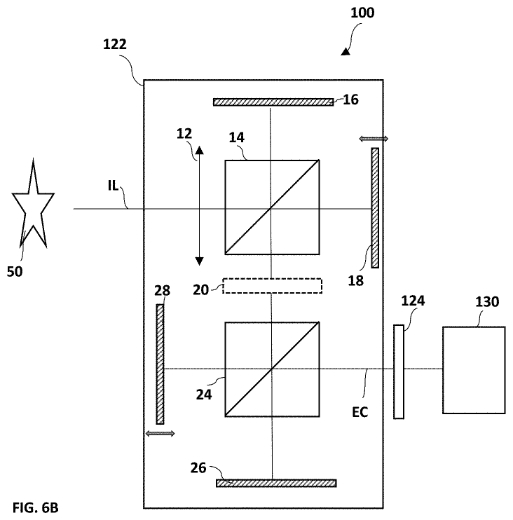

Additional configurations of the spatial filter 122 may utilize coherence coding by interferometric unit configured for interfering at least two copies of the collected light with selected axial or temporal coding, providing enhanced spatial coherence in the output light. Reference is made to FIGS. 6A and 6B exampling a configuration of system 100 for monitoring an object 50 using interferometric spatial filter 122. Generally, the spatial filter 122 may be designed using axial and/or temporal coding techniques described in V. Mico et al, “Spatial Information Transmission Using Axial Temporal Coherence Coding,” Opt. Lett. 32, 736-738 (2007); Z. Zalevsky et al, “Spatial information transmission using orthogonal mutual coherence coding,” Opt. Lett. 20, 2837-2839 (2005); and V. Mico at al, “Depth sensing using coherence mapping,” Opt. Commun. 283, 3122-3128 (2010) all incorporated herein by reference in connection with optical arrangement for enhancing coherence of collected light. It should however be noted, and as indicated further below, that the present technique utilizes variations in speckles that can be achieved from the encoded and/or decoded signals. Accordingly, the present technique does not require decoding of the collected spatial information of the light and thus simplifies its configuration.

As shown in FIG. 6A, system 100 includes spatial filter 122 configured for collecting light IL (e.g. IR radiation or reflection due to ambient illumination) arriving from an object 50. The spatial filter 122 includes input lens arrangement 12 positioned and configured for determined field of view and directing collected light onto first (encoding) beam splitter 14. Beam splitter 14 is positioned to receive collected light for splitting the collected light toward first 16 and second 18 reflecting surfaces and combine the reflect light to provide output interfered light EC. The output light EC is directed to detector array 130 configured for collecting image data pieces at a selected frame rate and generate at least one sequence of image data piece indicative of speckle patterns in the collected light EC. As indicated above, the system may also include spectral filter 124, exemplifies as located downstream of the spatial filter unit 122, but may also be located upstream thereof, or in any location along path of propagation of the collected light; and may also include imaging lens arrangement 110. The imaging lens arrangement is positioned to provide selected level of focus or defocused imaging of the object 50.

In the example of FIG. 6B, the collected light is also decoded by transmitting the collected light via additional interferometric unit. In this example, an optical arrangement may be positioned downstream of first beam splitter and configured for directing light into second (decoding) beam splitter 24. The second beam splitter 24 is configured to direct light to first 26 and second 28 decoding reflecting surfaces and provide output decoded light EC having enhanced coherence with respect to input light IL. A spectral filter 124 may be positioned upstream, downstream or at a selected intermediate position with respect to spatial filter 122 and allowing transmission of selected wavelength range having a relatively narrow band (e.g. range of about 100-10 nm). The so filtered light is collected by detector array 130 at a selected frame/sampling rate for generating at least one sequence of image data piece, where each image data piece includes one or more speckle patterns formed in collected light arriving from different locations within the object 50.

Generally, in some configurations, at least one of the encoding reflecting surface (e.g. mirror 18) and decoding reflecting surface (e.g. mirror 28), when used, may be movable along optical axis thereof for determined length of the respective interferometer arm. Selection of axial location of mirror 28 with respect to mirror 18 enables determining axial depth of inspection region used for monitoring, while requiring no active illumination of any contact with the object 50.

Thus, spatial filter 122 according to the example of FIG. 6A includes a beam splitting element separating input radiation into first and second arms, where the radiation components propagated selected paths. Light transmitted through the first and second arms is combined to provide output interfered light EC. In the Examine of FIG. 6B, the spatial filter further includes a second beams splitting element configured to receive interfered light from the first beam splitting element and separates it to fourth and fifth arms, in which the radiation propagates along selected paths to provide the output interfered light.

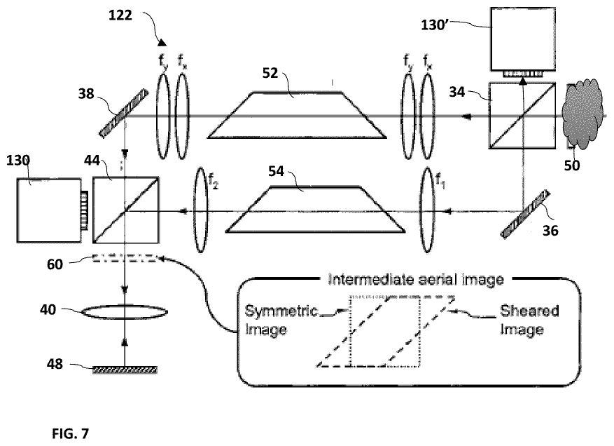

An additional configuration of the spatial filter 122 is illustrated in FIG. 7. In this configuration, input light arriving from object 50 is directed to first beam splitter 34 to propagate through a first spherical path and a second sheared path. The light components are combined providing interfered light output. In the first spherical path, the light passes through magnification lens arrangement including lenses f1 and f2 (e.g. after being redirected by mirror 36), positioned on two sides of a dove prism 54 configured for inverting the image with respect to a selected plane. In the second sheared path, light passed through different x- and y-magnification system formed by lenses fx and lenses fy positioned on two sides of dove prism 52. Mirror 38 and second beam splitter 44 combine the optical paths and is positioned to direct the combined light field (overlay image) toward detector 130. Typically, as indicated above a spectral filter and/or imaging lane arrangement may also be used but not specifically shown here. Overlay intermediate image 60 exemplify structure of the combined image. In some configurations, lens 40 and mirror 48 are used to reflect the light for a second path through the spatial filter 122 toward alternative position of the detector 130′. Generally, encoding the collected light by a signal passage through the spatial filter 122 is sufficient to enhance coherence of the collected light and generate spackle pattern suitable for monitoring parameters of the object 50. In some configurations, a second passage of light for decoding the coherence pattern formed by passing light through the spatial filter is used. Thus, the collected light may pass once or twice through the interferometer filter unit.

It should be noted that additional configurations of the interfering optical arrangement 122 may be used. For example, interfering configuration as described in “Depth sensing using coherence mapping,” Opt. Commun. 283, 3122-3128 (2010) indicated above may be used. Such configuration may utilize collection of light reflected from the object 50 combined with reference light field. Further, additional various configurations providing enhanced spatial coherence of light may act as spatial filter.

Thus, the present invention provides a technique and corresponding system enabling monitoring parameters of an object, e.g. living organ, individual biomedical parameters etc., using thermal radiation and/or reflection of ambient illumination collected from the object. As indicated, the technique includes collecting radiation arriving from a selected region of the object, while applying at least one of spatial and spectral filtering to the collected radiation for enhancing coherence of the collected radiation. This enables detection of speckle patterns in the collected light. The technique further includes generating at least one sequence of image data pieces, each including at least one speckle pattern and processing the speckle patterns for determining a variation function indicating changes in the speckle patterns over time. It should be noted that the present technique utilizes passive components for collection of radiation from the object and utilizes generally incoherent (e.g. thermal) radiation for speckle-based sensing by tracking the dynamics of the speckles. The technique is suitable for use with any selected wavelength, in accordance with selection of proper optics and detector array.

1. A system comprising: optical arrangement, filtering unit and a detector unit; the optical arrangement is configure for collecting light arriving from a sample, directing the collected light to the filtering unit for filtering based on at least one of spatial and spectral composition and directing the collected light onto the detector unit, the optical arrangement and the detector unit are arranged to provide imaging of collected light from the sample on the detector unit with selected focusing/defocusing level.

2. The system of claim 1, configured for generating detector output data comprising of one or more image data pieces, said image data pieces comprising speckle patterns formed in light collected from the sample.

3. The system of claim 1, wherein said filtering unit comprises at least one of spatial filtering unit and spectral filtering unit.

4. The system of claim 1, wherein said filtering unit comprises a coherence shaping unit configured for enhancing at least one of spatial and temporal coherence properties of the collected light, thereby increasing contrast of speckle pattern formed in the collected light.

5. The system of claim 1, wherein said filtering unit comprises spatial filtering unit and spectral filtering unit; the spatial filtering unit is configured for enhancing coherence of light components collected from a common spatial position on the sample, said spectral filtering unit is configured for filtering light components for directing light components of a selected wavelength range onto a one or more defined regions on the detector unit.

6. The system of claim 1, wherein said spectral filtering unit comprises one or more dichroic filters configured for transmitting or reflecting a selected wavelength range.

7. The system of claim 1, wherein said optical arrangement is positioned to provide defocused imaging of the object, thereby generating defocused image of collected light on the detector unit.

8. The system of claim 7, wherein said defocused image form one or more speckle patterns of the detector unit, said detector unit being configured for collecting image data pieces indicative of said one or more speckle patterns at a selected sampling rate to provide image data sequence comprising at least one sequence of speckle patterns.

9. The system of claim 1, further comprising a control unit connected to at least said detector array and configured for receiving detector output data comprising one or more sequences of image data pieces and for processing said one or more sequences and determining data indicative of one or more parameters of the sample.

10. The system of claim 9, wherein said control unit comprises at least one processor unit, said control unit is adapted for receiving image data pieces from the detector array and for operating the processor unit for processing said image data pieces for determining variations in speckle patterns in accordance with sampling rate of the detector array.

11. The system of claim 10, wherein said processing comprises determining variation in spatial correlation between speckle pattern in different image data pieces, and determining a time-correlation function, said time-correlation function is indicative of variations in at least one of location and orientation of surface of the sample.

12. The system of claim 1, wherein said spatial filtering is provided by a spatial filtering unit configures as an interferometric unit configured for generating output light being a result of interference of at least two copies of collected light arriving from the object.

13. The system of claim 12, wherein said interferometric unit comprises a beam splitting element configured to receive collected light and split the collected light to form said at least two copies, said interferometric unit further comprises at least first and second arms allowing light components of said at least two copies to propagate therethrough along selected optical paths, and to combine light components from said first and second arms to provide output light.

14. The system of claim 1, wherein said collected light arriving from the sample comprises thermal radiation emitted for the sample or ambient light reflected from the sample.

15. The system of claim 1, wherein spatial filtering unit providing said spatial filtering comprises a selected aperture or pinhole and utilizing one or more scattering medium associated with the sample and located downstream of the aperture with respect to direction of propagation of collected radiation.

16. The system of claim 15, wherein said spatial filtering unit is formed by an aperture unit mounted on an endoscope, said one or more scattering medium being associated with additional tissue located exterior from the aperture unit.

17. A method for monitoring an object, the method comprising collecting electromagnetic radiation originating from the object by thermal radiation or reflection of ambient light, passing the collected radiation through at least one of spectral and spatial filter for enhancing coherence of the collected radiation, and collecting image data pieces at a selected sampling rate, the image data pieces comprise speckle patterns formed in the collected radiation.

18. The method of claim 17, further comprising processing the collected image data pieces for determining variations in the speckle pattern along time, and determining one or more parameters of the object.

19. The method of claim 18, wherein said processing comprises determining correlations between image data piece to determine spatial variations of the speckle patterns between time of acquisition of said image data pieces and determining at least one time-correlation function indicative of one or more parameters of said object.

20. The method of claim 17, wherein said passing the collected light through at least one of spectral and spatial filter comprises passing the collected light through at least one spectral filter having bandpass width not exceeding 0.5 nm, and passing the collected light through a spatial filter for enhancing spatial coherence of the collected light.
